(19) United States
(12) Patent Application Publication
(10) Pub. No.: US 2026/0357676 A1
(43) Pub. Date: Nov. 12, 2026

(54) MITIGATING SCALE FORMATION USING HYDROPHOBIC COATINGS ON INFLOW CONTROL COMPONENTS

(71) Applicant: Saudi Arabian Oil Company, Dhahran (SA)

(72) Inventors: Tao Chen, Dhahran (SA); Qiwei Wang, Dhahran (SA)

(21) Appl. No.: 19/202,416

(22) Filed: May 8, 2025

(51) Int. Cl. E21B 37/06; C09D 5/16; C09D 7/40; C09D 7/61; C09D 127/12; C09D 163/00

(52) U.S. Cl. CPC E21B 37/06; C09D 5/1618; C09D 5/1668; C09D 7/61; C09D 7/67; C09D 127/12; C09D 163/00

(57) ABSTRACT

A system is provided including a wellbore formed in a subterranean formation. The wellbore includes production tubing in fluid communication with a fluid positioned in the subterranean formation. The system includes an inflow control component coupled to the production tubing, where the inflow control component is configured to regulate a flow of the fluid from the subterranean formation to an interior of the production tubing. The system includes a coating disposed on an internal passageway of the inflow control component. The coating includes a hydrophobic component including diamond-like carbon, a fluoropolymer, a hydrophobic ceramic, a hydrophobic epoxy resin, or combinations thereof. The coating includes nanoparticles including zinc oxide nanoparticles, titanium oxide nanoparticles, or combinations thereof.

### TECHNICAL FIELD

Embodiments of the disclosure generally relate to coatings for inflow control components. More specifically, embodiments of this disclosure relate to mitigating scale formation using hydrophobic coatings on inflow control components.

### BACKGROUND

Inflow control valves and inflow control devices are components installed as part of a wellbore to partially or completely choke flow into a portion of a wellbore. Inflow control valves and inflow control devices can be installed along the reservoir section of the wellbore, with each device typically separated from the next via a packer. Inflow control valves and inflow control devices may allow the entire length of the wellbore to contribute to the total production and thereby optimize hydrocarbon recovery.

However, solids deposition may occur inside of inflow control valves and inflow control devices. The solid may deposit in different scenarios, for example, CaCO₃ deposition may occur due to the pressure change during the production stage and CaCO₃/CaSO₄/BaSO₄ deposition due to the incompatibility of production fluids and drilling fluids containing high concentrations of Ca/Ba ions during the drilling stage. When the scale is deposited inside the inflow control device or inflow control valve, it can cause plugs within the devices. In some cases, the scale-plugged inflow control device or inflow control valve cannot be effectively removed by chemical dissolution treatment as it is difficult for the chemicals to access inside the devices due to the scale blockage. Even more, the plugged devices may become so severely scaled that the device cannot be opened or re-setup mechanically due to the tight blockage and strong adhesion of the scale crystals on the surfaces.

Scale formation is a complex process that involves several steps, including nucleation, crystal growth, and deposition in the supersaturated waters. These steps can proceed either in series or parallel. Nucleation can occur either on the surface (heterogeneous nucleation) or in bulk solution (homogeneous). For the scale particles formed in bulk solution, deposition is an important step to becoming scale deposits; otherwise, they will flow with water in a suspended state and cause no harm to the production system or equipment.

One of the most common approaches to controlling inorganic scale deposition is the use of threshold scale inhibitors, such as phosphonates, polyacrylates, polymaleates, etc. These chemicals can delay or reduce scale formation when added in a small, or sub-stoichiometric, amount to scaling water. To be effective, the inhibitor should be present in the water continuously so that it is available to inhibit the growth of each scale crystal as it precipitates from the water. An inhibitor can be applied via either continuous chemical injection or a squeeze treatment. Although scale inhibitor treatment can be effective to mitigate scale deposition during the production stage, it can be costly. Further, most scale inhibitors may not work effectively to inhibit scale deposition during the drilling stage due to the compatibility issue between the scale inhibitors and extremely high Ca/Ba-containing drilling fluids.

Scale dissolution treatment is an alternative approach to removing scale deposition. However, the plugs generated by scale in inflow control valves and inflow control devices typically cannot be effectively removed by chemical dissolution treatment as the chemicals are difficult to access inside such devices due to the scale blockage.

### SUMMARY

Embodiments of the present disclosure provide system. The system includes a wellbore formed in a subterranean formation. The wellbore has production tubing in fluid communication with a fluid positioned in the subterranean formation. The system includes an inflow control component coupled to the production tubing. The inflow compound is configured to regulate a flow of the fluid from the subterranean formation to an interior of the production tubing. The system includes a coating disposed on a surface of an internal passageway of the inflow control component. The coating includes a hydrophobic component. The hydrophobic component includes diamond-like carbon, a fluoropolymer, a hydrophobic ceramic, a hydrophobic epoxy resin, or combinations thereof. The coating includes metal oxide nanoparticles.

In another embodiment, the present disclosure provides a method. The method includes contacting a fluid from a subterranean formation with an inflow control component. In some embodiments, the inflow control component is coupled to production tubing positioned inside a wellbore formed in the subterranean formation. The inflow control component is configured to regulate a flow of the fluid from the subterranean formation to an interior of the production tubing. The inflow control component includes a coating disposed on an internal passageway of the inflow control component. The coating includes a hydrophobic component. The hydrophobic component includes diamond-like carbon, a fluoropolymer, a hydrophobic ceramic, a hydrophobic epoxy resin, or combinations thereof. The coating includes metal oxide nanoparticles.

The details of one or more implementations of the subject matter of this specification are set forth in the detailed description, the accompanying drawings, and the claims. Other features, aspects, and advantages of the subject matter will become apparent from the detailed description, the claims, and the accompanying drawings.

### DESCRIPTION OF THE DRAWINGS

FIG. 1 is a schematic drawing of a coating according to an embodiment of the present disclosure.

FIG. 2 is a schematic drawing of a wellbore system according to an embodiment of the present disclosure.

FIG. 3 is a schematic drawing of an inflow control component according to an embodiment of the present disclosure.

FIG. 4 is a schematic drawing of an inflow control component according to an embodiment of the present disclosure.

FIG. 5 is a perspective view of a valve according to an embodiment of the present disclosure.

FIG. 6 is a cross-sectional view of the valve of FIG. 5 according to an embodiment of the present disclosure.

Like reference numbers and designations in the various drawings indicate like elements.

### DETAILED DESCRIPTION

The present disclosure relates to a coating disposed on an internal passageway of an inflow control component of a wellbore and methods of using the same to mitigate, or otherwise prevent, the formation of scale deposits within the inflow control component. The provided coating and method provide practical applications and technical advantages that address various problems associated with scale deposits within the inflow control components. As noted above, inflow control components, such as inflow control valves and inflow control devices, include narrow internal passageways that are prone to plugging due to scale deposition and accumulation. Plugging leads to premature failure of inflow control components and can be costly to mitigate using scale inhibitor treatments, dissolution treatments, or mechanical removal of scale.

Embodiments of this approach provide a coating that mitigates, or otherwise prevents, scale deposition inside of inflow control components. In some embodiments, the coating is disposed on an internal passageway of the inflow control component. In some embodiments, the coating comprises a hydrophobic component and metal oxide nanoparticles. Without wishing to be bound to a particular theory, it is contemplated that the coating provided herein can have hydrophobic or superhydrophobic properties that mitigate, or otherwise prevent, water from entering an internal passageway of the inflow control component. The provided coating favors the formation of an oil or gas film between surfaces within the internal passageway of the inflow control component, which can mitigate, or otherwise prevent, produced water from entering the internal passageways inside of the inflow control component. This, in turn, helps to mitigate, or otherwise eliminate, scale deposition inside the internal passageway of the inflow control component. The provided coating provides several benefits. By mitigating scale deposition, the provided coating reduces premature failure of the inflow control component and improves long term performance of the inflow control component. Additionally, the provided coating can reduce chemical inhibitor consumption and related costs, thereby reducing overall operating expenditures.

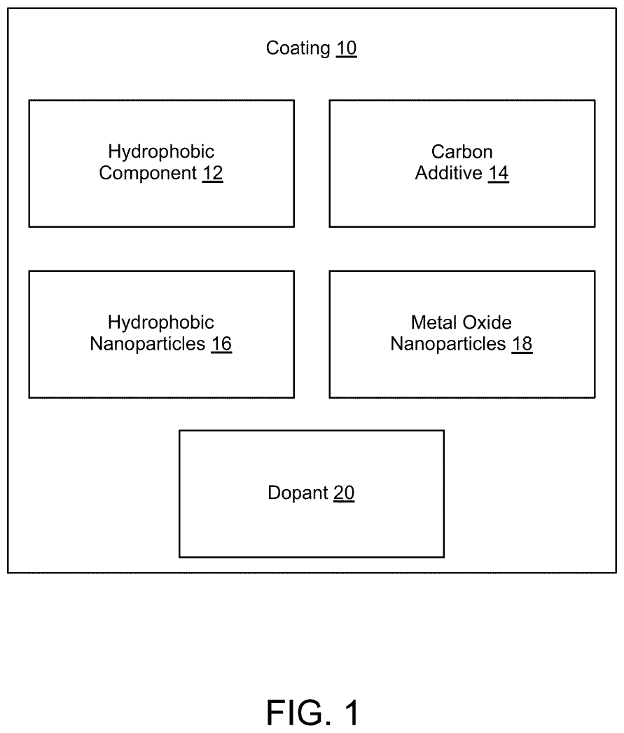

Referring to FIG. 1, a coating 10 is illustrated according to some embodiments of the present disclosure. In some embodiments, the coating 10 includes a hydrophobic component 12. In some embodiments, the hydrophobic component 12 includes diamond-like carbon (DLC), a fluoropolymer, a hydrophobic ceramic, a hydrophobic epoxy resin, or combinations thereof. In some embodiments, the hydrophobic component 12 is present in the coating 10 in an amount from 50 wt. % to 99.9 wt. %, based on a total weight of the coating 10. In some embodiments, the hydrophobic component 12 is present in an amount of at least 50 wt. % (e.g., at least 55 wt. %, at least 60 wt. %, at least 65 wt. %, at least 70 wt. %) and/or to at most 99.9 wt. % (e.g., at most 99 wt. %, at most 95 wt. %, at most 90 wt. %, at most 85 wt. %, at most 80 wt. %, at most 75 wt. %), based on the total weight of the coating 10.

In some embodiments, the hydrophobic component 10 includes DLC. In some embodiments, the DLC includes an amorphous carbon structure which is a mixture of sp³ bonded diamond, graphitic sp² carbon, and contains hydrogen atoms. If the sp² type is predominant, the DLC film can be softer, whereas if the sp³ type is predominant, the DLC film can be harder. The hydrophobic or superhydrophobic surface can reduce, or otherwise prevent, scale formation. DLC coatings are typically inert carbon films with various ratios of amorphous to crystalline carbon or carbon phases that give them attractive properties for inflow control components, such as high chemical resistance (inertness), good cohesion and adhesion to materials (e.g., carbon steels, stainless steels, nickel alloys), low friction coefficients (anti-stick properties) due to a slick surface finish. In addition to the hydrophobic properties, the smooth surface of DLC can have a lower tendency for scale formation by reducing an amount of nucleation sites that favor scale deposition. In some embodiments, the hydrophobic component 12 includes a fluoropolymer. In some embodiments, the fluoropolymer is a fluorocarbon-based polymer generated from at least one monomer unit having one or more carbon-fluorine bond. Exemplary fluoropolymers include, but are not limited to, polytetrafluoroethylene, polyvinylfluoride, polyvinylidene fluoride, polychlorotrifluoroethylene, perfluoroalkoxy polymer, fluorinated ethylene-propylene, polyethylenetetrafluoroethylene, polyethylenechlorotrifluoroethylene, or combinations thereof. In some embodiments, the coating 10 includes a carbon additive 14 dispersed therein. In some embodiments, the hydrophobic component 12 (e.g., the fluoropolymer) includes the carbon additive 14. The carbon additive 14 can further enhance the hydrophobicity of the coating 10 and/or the hydrophobic component 12. In some embodiments, the carbon additive 14 can include carbon fibers, carbon nanotubes, carbon black, graphite, or combinations thereof.

In some embodiments, the carbon additive 14 is present in an amount from 0.1 wt. % to 3 wt. %, based on the total weight of the coating 10. In some embodiments, the carbon additive 14 is present in an amount from at least 0.1 wt. % (e.g., at least 0.5 wt. %, at least 1 wt. %, at least 1.5 wt. %) and/or to at most 3 wt. % (e.g., at least 2.5 wt. %, at least 2 wt. %), based on the total weight of the coating 10.

In some embodiments, the hydrophobic component 12 includes a hydrophobic ceramic. As used herein, “a ceramic” can refer to a nonmetallic, inorganic, crystalline material, which can include compounds having an oxide, a nitride, a carbide, a boride, or combinations thereof. In some embodiments, the hydrophobic ceramic includes a non-oxide ceramic, such as silicon carbide. In some embodiments, the hydrophobic ceramic includes an oxide ceramic having a surface treated hydrophobic coating. The surface treated hydrophobic coating can impart hydrophobicity to an external surface of the oxide ceramic. In some embodiments, the surface treated hydrophobic coating can include silicone, a fluoropolymer, or combinations thereof. Exemplary fluoropolymers can include, but are not limited to, the fluoropolymers described above. In some embodiments, the hydrophobic component 12 includes a hydrophobic epoxy resin. Epoxy resins can include polyepoxides, which are a class of reactive prepolymers or polymers which contain epoxide groups. Epoxy resins can be reacted (that is, cross-linked) either with themselves through catalytic homopolymerisation, or with co-reactants such as polyfunctional amines, carboxylic acids, acid anhydrides, phenols, alcohols, and thiols. These co-reactants are often referred to as hardeners, and the cross-linking reaction is commonly referred to as curing. Reaction of polyepoxides with themselves or with polyfunctional hardeners forms a thermosetting polymer, often with strong mechanical properties as well as high temperature and chemical resistance.

In some embodiments, the hydrophobic epoxy resin includes a bisphenol A epoxy resin, bisphenol F epoxy resin, bisphenol S epoxy resin, biphenyl epoxy resin, naphthalene epoxy resin, an epoxy resin containing a dicyclopentadiene backbone, fluorene epoxy resin; novolac epoxy resins such as phenol novolac epoxy resin, and cresol novolac epoxy resin; biphenyl aralkyl epoxy resin, glycidyl amine epoxy resin, or combinations thereof.

In some embodiments, the hydrophobic epoxy resin includes a hardener. The hardener can include amines, acids, acid anhydrides, phenols, alcohols, thiols, or combinations thereof. Exemplary hardeners include, but are not limited to, aliphatic amines, aliphatic tertiary amines, aromatic amines, cycloaliphatic amines, heterocyclic amines, amido amines, polyamides, polyethyl amines, polyether amines, polyoxyalkylene amines, carboxylic anhydrides, carboxylic acids, triethylenetetraamine, ethylene diamine, N-cocoalkyltrimethylene, isophorone diamine, N-aminophenyl piperazine, imidazoline, 1,2-diaminocyclohexane, polytheramine, diethyltoluenediamine, 4,4′-diaminodiphenyl methane, methyltetrahydrophthalic anhydride, hexahydrophthalic anhydride, maleic anhydride, polyazelaic polyanhydride, phthalic anhydride, or combinations thereof.

In some embodiments, the hydrophobic epoxy resin includes hydrophobic nanoparticles 16 dispersed therein. In some embodiments, the hydrophobic nanoparticles 16 are added in an amount to increase the hydrophobicity of the hydrophobic epoxy resin, or otherwise cause the epoxy resin to be hydrophobic or superhydrophobic. In some embodiments, the hydrophobic nanoparticles 16 include, but are not limited to, fluoropolymer nanoparticles, silicon nanoparticles, or combinations thereof. Suitable fluoropolymers for the fluoropolymer nanoparticles can include, but are not limited to, those described above. In some embodiments, the hydrophobic nanoparticles 16 are present in an amount from 0.1 wt. % to 10 wt. %, based on the total weight of the coating 10. In some embodiments, the hydrophobic nanoparticles are present in an amount from at least 0.1 wt. % (e.g., at least 0.5 wt. %, at least 1 wt. %, at least 2 wt. %, at least 2.5 wt. %) and/or to at most 10 wt. % (e.g., at most 9 wt. %, at most 8 wt. %, at most 7 wt. %, at most 6 wt. %, at most 5 wt. %, at most 4 wt. %, at most 3.5 wt. %).

In some embodiments, the coating 10 includes metal oxide nanoparticles 18 dispersed therein. In some embodiments, the metal oxide nanoparticles 18 are added to enhance the hydrophobicity of the coating 10 and/or increase mechanical strength (e.g., hardness, flexibility, abrasion resistance) of the coating 10. In some embodiments, the metal oxide nanoparticles 18 include zinc oxide nanoparticles, titanium oxide nanoparticles, or combinations thereof. In some embodiments, the metal oxide nanoparticles 18 are present in an amount from 0.1 wt. % to 10 wt. %, based on the total weight of the coating 10. In some embodiments, the metal oxide nanoparticles 18 are present in an amount from at least 0.1 wt. % (e.g., at least 0.5 wt. %, at least 1 wt. %, at least 2 wt. %, at least 2.5 wt. %) and/or to at most 10 wt. % (e.g., at most 9 wt. %, at most 8 wt. %, at most 7 wt. %, at most 6 wt. %, at most 5 wt. %, at most 4 wt. %, at most 3.5 wt. %).

In some embodiments, the metal oxide nanoparticles 18 have a nanorod geometry. In some embodiments, the nanorods have a diameter from 5 nm to 900 nm. In some embodiments, the nanorods have a diameter of at least 5 nm (e.g., at least 10 nm, at least 15 nm, at least 20 nm, at least 30 nm, at least 40 nm, at least 50 nm, at least 100 nm, at least 150 nm, at least 200 nm, at least 250 nm, at least 300 nm) and/or at most 900 nm (e.g., at most 850 nm, at most 800 nm, at most 750 nm, at most 700 nm, at most 650 nm, at most 600 nm, at most 550 nm, at most 500 nm, at most 450 nm). In some embodiments, the metal oxide nanoparticles 18 have an aspect ratio (length: width) from 2 to 10. In some embodiments, the metal oxide nanoparticles 18 have an aspect ratio (length: width) of at least 2 (e.g., at least 3, at least 4, at least 5) and/or at most 10 (e.g., at most 9, at most 8, at most 7, at most 6).

In some embodiments, the coating 10 includes a dopant 20. In some embodiments, the dopant 20 includes fluorine, oxygen, nitrogen, silicone, or combinations thereof. In some embodiments, the dopant 20 is present in an amount from 0.1 wt. % to 0.5 wt. %, based on the total weight of the coating 10. In some embodiments, the dopant is present in an amount from at least 0.1 wt. % (e.g., at least 0.2 wt. %, at least 0.3 wt. %) and/or to at most 0.5 wt. % (e.g., at most 0.4 wt. %), based on the total weight of the coating 10.

In some embodiments, the coating 10 has a water contact angle from 90° to 180°. In some embodiments, the coating 10 has a water contact angle of at least 90° (e.g., at least 100°, at least 110°, at least 120°, at least 130°, at least 140°) and/or at most 180° (e.g., at most 170°, at most 160°, at most 150°).

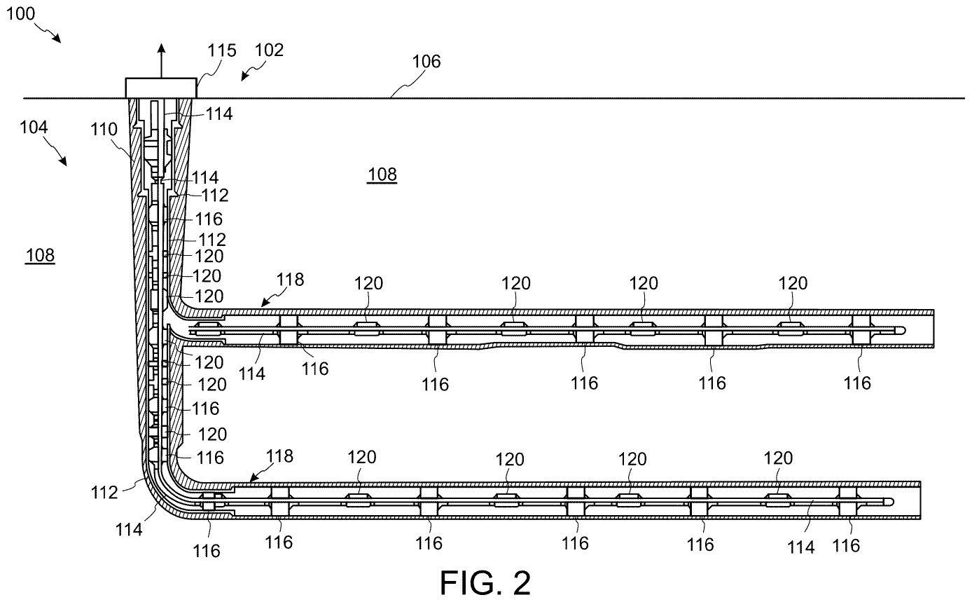

Referring to FIG. 2, a system 100 is shown that includes a hydrocarbon producing well 102. The system 100 includes a wellbore 104 formed through a surface 106 of the Earth into a subterranean formation 108. The subterranean formation 108 includes an oil reservoir comprising crude oil, water, gas, etc. The wellbore 104 includes a wellbore wall 110 that has been drilled to penetrate a portion of the subterranean formation 108. The wellbore 104 is formed out of one or more casing strings 112 disposed therein. The casing strings 112 of the wellbore wall 110 are a series of connected pipes that are lowered into the wellbore 104 and cemented in place to form the wellbore 104 within the subterranean formation 108.

Production tubing 114 is disposed in the wellbore 104. A wellbore head 115 is constructed at an entrance to the wellbore 104. The production tubing 114 is coupled to the wellbore head 115 and is configured to extend from the wellbore head 115 to a depth within the wellbore 104. The production tubing 114 is held in place within the wellbore 104 by one or more packers 116. For example, the packer(s) 116 are positioned between the wellbore wall 110 and the production tubing 114 to hold the production tubing 114 in place within the wellbore 104. The wellbore wall 110 includes one or more perforations 118 along a vertical section of the wellbore 104, where the production tubing 114 extends through the perforations 118 along a horizontal section of the wellbore 104.

In some embodiments, the system 100 includes inflow control component(s) 120 coupled to the production tubing 114. The inflow control component(s) 120 is configured to regulate a flow of fluid (e.g., crude oil, water, gas, or mixtures thereof) from the subterranean formation 108 to an interior of the production tubing 114 for different zones in the wellbore 104. In some embodiments, a single inflow control component 120 is positioned between two packers for each zone in the wellbore 104. In some embodiments, multiple inflow control components 120 are positioned between two packers 116 for each zone in the wellbore 104.

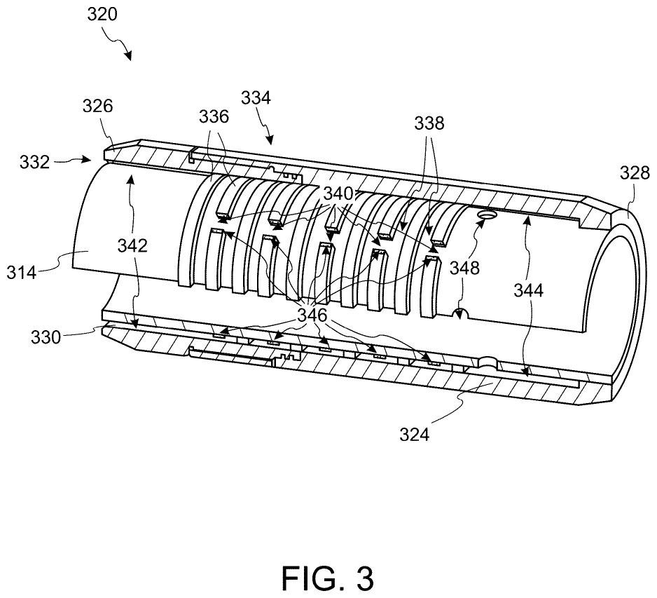

Referring to FIG. 3, an inflow control component 320 is illustrated according to some embodiments of the present disclosure. In some embodiments, the inflow control component 320 is an inflow control device. In some embodiments, the inflow control component 320 is coupled to the production tubing 114 and configured to regulate a flow of fluid from the subterranean formation 108 to an interior of the production tubing 114. In horizontal wells, early water or gas may breakthrough into the wellbore 104 due to the imbalanced production profile caused by a heel-toe effect, reservoir anisotropic, reservoir heterogeneity, or fracture-existing. Once coning occurs, a water and gas fast track may occur, which results in oil production being reduced due to limited flow contribution from non-coning regions. Inflow control components 320, such as inflow control devices, may be installed around production tubing 114 to create a pressure differential that mitigates, or otherwise cancels out, the imbalanced production profile. This reduces unwanted fluids from breaking through, thereby maximizing oil production.

In some embodiments, the inflow control component 320 includes a housing 324 that extends between a first end 326 and a second end 328. In some embodiments, the housing 324 has a cylindrical or tubular geometry that surrounds a portion of the production tubing 114. The first end 326 includes an opening 330 that allows fluid from the subterranean formation 108 to enter an internal passageway 332 of the inflow control component 320. The internal passageway 332 is a space formed between an outer surface of the production tubing 114 and an interior surface of the housing 324. In some embodiments, the second end 328 of the housing 124 is coupled to the production tubing 114 to form a seal that mitigates or prevents fluid from the subterranean formation 108 from entering the second end 328 of the housing 324. In some embodiments, the internal passageway 332 of the inflow control component 320 includes a flow field 334. The flow field 334 includes structure(s) 336 and/or channel(s) 338 that manipulate the flow of fluid within the internal passageway 332. The flow field 334 can have any suitable design including, but not limited to, a serpentine channel, an interdigitated channel, a straight parallel channel, pin type design, spiral channel, or multiple channel serpentine design.

The structures 336 extend between an outer surface of the production tubing 114 and an inner surface of the housing 324 and is spaced apart to form the channels 338. The structures 336 have gaps 340 that allow the fluid to flow between channels 338 of the flow field 334. In some embodiments, the gaps 340 include a water swellable rubber 346. The water swellable rubber 346 can swell in the presence of water, which will adjust the size of the gaps 340 automatically according to water content, thus changing the flow resistance through the gaps 340. The water swellable rubber 346 can assist to allow the passage of oil while minimizing the passage of water. In some embodiments, the internal passageway 332 includes an upper annulus 342. The upper annulus 342 is the space between the opening 330 at the first end 326 of the housing 324 and an entrance to the flow field 334. In some embodiments, the internal passageway 332 includes a lower annulus 344. The lower annulus 344 is the space between the second end 328 and an exit of the flow field 334. The lower annulus 344 includes one or more openings 348 that place the inflow control component 320 in fluid communication with an interior of the production tubing 114.

In some embodiments, the coating 10 is disposed on a surface of the internal passageway 334. In some embodiments, the coating 10 is be disposed on the exterior surface of the production tubing 114 and the interior surface of the housing 324 in the upper annulus 342. In some embodiments, the coating 10 is be disposed on surfaces of the structures 136 and channels 138. In some embodiments, the coating 10 is be disposed on the exterior surface of the production tubing 114 and the interior surface of the housing 324 in the lower annulus 344. In some embodiments, the coating 10 is be disposed on a surface of the openings 348. The coating 10 can be deposited onto such surfaces using any suitable method including, but not limited to, magnetron sputtering, chemical vapor deposition (CVD), pulsed laser deposition (PLD), direct ion beam, or ion beam-assisted cathodic arc deposition.

During operation, fluid from the subterranean formation 108 contacts the inflow control component 320. The hydrophobic or superhydrophobic property of the coating 10 can allow oil or gas to enter the opening 330 of the internal passageway 332, while mitigating or preventing water from entering the internal passageway 332. The oil and gas layers on the coating 10 can build a barrier to prevent the contact of scaling water inside of the internal passageway 332 of the inflow control component 320. The water-repelling property of the coating 10 within the internal passageway 332 mitigates, or otherwise prevents, fresh scaling brines from entering the internal passageway 332, which reduces the risk of scale deposition within the inflow control component 320. Additionally, the adhesion of scale on hydrophobic or superhydrophobic surfaces, such as the coating 10, are much weaker than on bare metal surfaces of production tubing 114 or inflow control components 320. Even if the coating 10 becomes plugged by scale deposition, the weak adhesion of scale to the coating 10 allows for the scale to be removed via mechanical intervention.

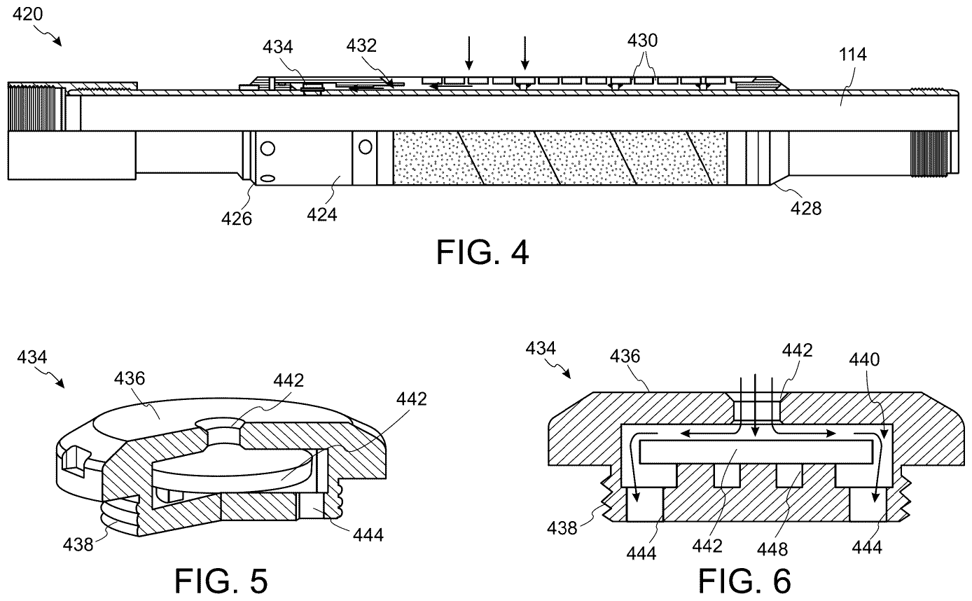

Referring to FIG. 4, an inflow control component 420 is illustrated according to some embodiments of the present disclosure. In some embodiments, the inflow control component 420 is an inflow control valve. In some embodiments, the inflow control component 420 is coupled to the production tubing 114 and configured to regulate a flow of fluid from the subterranean formation 108 to an interior of the production tubing 114. In some embodiments, the inflow control component 420 includes a housing 424 that extends between a first end 426 and a second end 428. In some embodiments, the housing 424 has a cylindrical or tubular geometry that surrounds a portion of the production tubing 114. In some embodiments, the housing 424 includes opening(s) 430 positioned between the first end 426 and the second end 428 that allow fluid from the subterranean formation 108 to enter an internal passageway 432 of the inflow control component 420.

The internal passageway 432 is a space formed between an outer surface of the production tubing 114 and an interior surface of the housing 424. In some embodiments, the internal passageway 432 is in fluid communication with a valve 434 that regulates the flow of fluid between the internal passageway 432 and an interior of the production tubing 114. In some embodiments, the coating 10 is disposed on an exterior surface of the production tubing and an interior surface of the housing 424. In some embodiments, the coating 10 is disposed on a surface of the openings 430. As discussed above, the hydrophobic or superhydrophobic property of the coating 10 can allow oil or gas to enter the opening 430 of the internal passageway 432, while mitigating or preventing water from entering the internal passageway 432.

Referring to FIGS. 5-6, the valve 434 includes a top plate 436 coupled to a body 438. In some embodiments, the valve 434 includes an interior space 440 formed between the top plate 436 and the body 438. The top plate 436 includes an inlet 442 that is configured to receive fluid from the internal passageway 432. The inlet 442 places the internal passageway 432 in fluid communication with the interior space 440 of the valve 434. The body 438 includes outlet(s) 444 that place the interior space 440 in fluid communication with an interior of the production tubing 114. The interior space 440 includes a plate 446. The body 438 includes a seat 448 configured to receive the plate 446 in the interior space 440. The position of the plate 446 in the valve 434 depends on the type of fluid entering the valve 434 through the inlet 442. In particular, the plate 446 will float in the interior space 440 or rest on the seat 448 when viscous fluids, such as oil, pass through the valve 434 and will press against the inlet 442 to restrict, or otherwise prevent, the flow of fluids with lower viscosity, such as water and gas. Different pressures act on the plate 446 when different fluid flow through the valve 434. For higher viscosity fluids, like oil, the pressure drop through the valve 434 is high, creating a low force on the plate 446. In contrast, low viscosity fluids, like water and gases, create a high upward force on the plate 446 that closes the inlet 442. In some embodiments, the coating 10 is be disposed on a surface of the inlet 442, a surface of the interior space 440, a surface of plate 446, a surface of the seat 448, a surface of the outlet(s) 444, or a combination thereof.

In some embodiments, the coating 10 may be disposed on the respective surfaces discussed herein with a thickness from 5 to 200 μm. In some embodiments, the coating 10 may be disposed on the respective surfaces with a thickness from at least 5 μm (e.g., at least 10 μm, at least 15 μm, at least 20 μm, at least 30 μm, at least 40 μm, at least 50 μm, at least 100 μm) and/or to at most 200 μm, (e.g., at most 190 μm, at most 180 μm, at most 170 μm, at most 160 μm, at most 150 μm).

In an example implementation, a system is provided. The system includes a wellbore formed in a subterranean formation. The wellbore has production tubing in fluid communication with a fluid positioned in the subterranean formation. The system includes an inflow control component coupled to the production tubing. The inflow compound is configured to regulate a flow of the fluid from the subterranean formation to an interior of the production tubing. The system includes a coating disposed on a surface of an internal passageway of the inflow control component. The coating includes a hydrophobic component. The hydrophobic component includes diamond-like carbon, a fluoropolymer, a hydrophobic ceramic, a hydrophobic epoxy resin, or combinations thereof. The coating includes metal oxide nanoparticles.

In an example implementation combinable with any other example implementation, the metal oxide nanoparticles are present in the coating in an amount from 0.1 wt. % to 10 wt. %, based on a total weight of the coating.

In an example implementation combinable with any other example implementation, the metal oxide nanoparticles comprise zinc oxide nanoparticles, titanium oxide nanoparticles, or combinations thereof.

In an example implementation combinable with any other example implementation, the dopant comprises fluorine, oxygen, nitrogen, silicon, or combinations thereof.

In an example implementation combinable with any other example implementation, the fluoropolymer comprises polytetrafluoroethylene.

In an example implementation combinable with any other example implementation, the fluoropolymer includes a carbon additive. The carbon additive comprises carbon fibers, carbon nanotubes, carbon black, graphite, or combinations thereof.

In an example implementation combinable with any other example implementation, the carbon additive is present in an amount from 0.1 wt. % to 3 wt. %, based on a total weight of the coating.

In an example implementation combinable with any other example implementation, the hydrophobic ceramic comprises silicon carbide.

In an example implementation combinable with any other example implementation, the hydrophobic ceramic comprises a ceramic material surface treated with a hydrophobic material. The hydrophobic material comprises silicone, a fluoropolymer, or combinations thereof.

In an example implementation combinable with any other example implementation, the epoxy resin comprises a polyepoxide having a hydrophobic nanoparticles.

In an example implementation combinable with any other example implementation, the hydrophobic nanoparticles comprise fluoropolymer nanoparticles, silicon nanoparticles, or combinations thereof.

In an example implementation combinable with any other example implementation, the hydrophobic nanoparticles are present in an amount from 0.1 wt. % to 10 wt. %, based on a total weight of the coating.

In an example implementation combinable with any other example implementation, the coating has a water contact angle of at least 90 ° to less than 180 °.

In an example implementation combinable with any other example implementation, the inflow control component is an inflow control valve.

In an example implementation combinable with any other example implementation, the inflow control component is an inflow control device.

In an example implementation combinable with any other example implementation, a method is provided. The method includes contacting a fluid from a subterranean formation with an inflow control component. The inflow control component is coupled to production tubing positioned inside a wellbore formed in the subterranean formation. The inflow control component is configured to regulate a flow of the fluid from the subterranean formation to an interior of the production tubing. The inflow control component includes a coating disposed on an internal passageway of the inflow control component. The coating comprises a hydrophobic component. The hydrophobic component comprises comprising diamond-like carbon, a fluoropolymer, a hydrophobic ceramic, a hydrophobic epoxy resin, or combinations thereof. The coating comprises metal oxide nanoparticles.

In an example implementation combinable with any other example implementation, the nanoparticles are present in the coating in an amount from 0.1 wt. % to 10 wt. %, based on a total weight of the coating. The nanoparticles comprise zinc oxide nanoparticles, titanium oxide nanoparticles, or combinations thereof.

In an example implementation combinable with any other example implementation, the fluoropolymer comprises polytetrafluoroethylene.

In an example implementation combinable with any other example implementation, the hydrophobic ceramic comprises silicon carbide, a ceramic material surface treated with a hydrophobic material, or combinations thereof.

In an example implementation combinable with any other example implementation, the epoxy resin comprises a polyepoxide having a hydrophobic additive.

1. A system comprising:
a wellbore formed in a subterranean formation, the wellbore having production tubing in fluid communication with a fluid positioned in the subterranean formation;
an inflow control component coupled to the production tubing, wherein the inflow control component is configured to regulate a flow of the fluid from the subterranean formation to an interior of the production tubing;
a coating disposed on a surface of an internal passageway of the inflow control component, wherein the coating comprises:
a hydrophobic component comprising diamond-like carbon, a fluoropolymer, a hydrophobic ceramic, a hydrophobic epoxy resin, or combinations thereof, wherein the hydrophobic component is present in the coating in an amount from 50 wt. % to 99.9 wt. %, based on a total weight of the coating; and
metal oxide nanoparticles dispersed in the hydrophobic component, wherein the metal oxide nanoparticles are present in the coating in an amount from 0.1 wt. % to 10 wt. %, based on the total weight of the coating.

2. (canceled)

3. The system of claim 1, wherein the metal oxide nanoparticles comprise zinc oxide nanoparticles, titanium oxide nanoparticles, or combinations thereof.

4. The system of claim 1, wherein the coating further comprises a dopant, wherein the dopant comprises fluorine, oxygen, nitrogen, silicon, or combinations thereof.

5. The system of claim 1, wherein the fluoropolymer comprises polytetrafluoroethylene.

6. The system of claim 1, wherein the fluoropolymer includes a carbon additive, wherein the carbon additive comprises carbon fibers, carbon nanotubes, carbon black, graphite, or combinations thereof.

7. The system of claim 6, wherein the carbon additive is present in an amount from 0.1 wt. % to 3 wt. %, based on a total weight of the coating.

8. The system of claim 1, wherein the hydrophobic ceramic comprises silicon carbide.

9. The system of claim 1, wherein the hydrophobic ceramic comprises a ceramic material surface treated with a hydrophobic material, wherein the hydrophobic material comprises silicone, a fluoropolymer, or combinations thereof.

10. The system of claim 1, wherein the epoxy resin comprises a polyepoxide having a hydrophobic nanoparticles.

11. The system of claim 10, wherein the hydrophobic nanoparticles comprise fluoropolymer nanoparticles, silicon nanoparticles, or combinations thereof.

12. The system of claim 10, wherein the hydrophobic nanoparticles are present in an amount from 0.1 wt. % to 10 wt. %, based on a total weight of the coating.

13. The system of claim 1, wherein the coating has a water contact angle of at least 90 ° to less than 180 °.

14. The system of claim 1, wherein the inflow control component is an inflow control valve.

15. The system of claim 1, wherein the inflow control component is an inflow control device.

16. A method comprising:
contacting a fluid from a subterranean formation with an inflow control component, wherein the inflow control component is coupled to production tubing positioned inside a wellbore formed in the subterranean formation, wherein the inflow control component is configured to regulate a flow of the fluid from the subterranean formation to an interior of the production tubing; and
wherein the inflow control component includes a coating disposed on an internal passageway of the inflow control component; and
wherein the coating comprises:
a hydrophobic component comprising diamond-like carbon, a fluoropolymer, a hydrophobic ceramic, a hydrophobic epoxy resin, or combinations thereof, wherein the hydrophobic component is present in the coating in an amount from 50 wt. % to 99.9 wt. %, based on a total weight of the coating; and
metal oxide nanoparticles dispersed in the hydrophobic component, wherein the metal oxide nanoparticles are present in the coating in an amount from 0.1 wt % to 10 wt. %, based on the total weight of the coating.

17. The method of claim 16,
wherein the nanoparticles comprise zinc oxide nanoparticles, titanium oxide nanoparticles, or combinations thereof.

18. The method of claim 16, wherein the fluoropolymer comprises polytetrafluoroethylene.

19. The method of claim 16, wherein the hydrophobic ceramic comprises silicon carbide, a ceramic material surface treated with a hydrophobic material, or combinations thereof.

20. The method of claim 16, wherein the epoxy resin comprises a polyepoxide having a hydrophobic additive.
